(19) United States
(12) Patent Application Publication
(10) Pub. No.: US 2015/0277679 A1
(43) Pub. Date: Oct. 1, 2015

(54) AUTOMATICALLY SELECTING AND DOWNLOADING A NEXT-READ EBOOK TO AN ELECTRONIC READING DEVICE

(71) Applicant: Kobo Incorporated, Toronto (CA)

(72) Inventor: Tai Yip TOH, Toronto (CA)

(73) Assignee: Kobo Incorporated, Toronto (CA)

(21) Appl. No.: 14/230,542

(22) Filed: Mar. 31, 2014

(51) Int. Cl. G06F 3/0483; H04L 29/08; G06F 3/0484

(52) U.S. Cl. CPC G06F 3/0483; G06F 3/04842; H04L 67/1078

(57) ABSTRACT

A method and system for automatically selecting and downloading a next-read electronic book (eBook) to an electronic reading device is disclosed. One example determines a current eBook being accessed by a user on the electronic reading device. Prior to the user finishing the current eBook, an e-library is accessed and a next-read eBook is automatically selected and downloaded based on an aspect of the current eBook. In addition, the next-read eBook is automatically provided to the user when the user finishes reading the current eBook. When a predefined next-read eBook use metric has been met, the electronic reading device automatically provides payment to purchase the next-read eBook.

### BACKGROUND

An electronic reading device, also known as an eReader, is an electronic personal display that is used for reading electronic books (eBooks), electronic magazines, and other digital content. For example, digital content of an eBook is displayed as alphanumeric characters and/or graphic images on a display of an eReader such that a user may read the digital content much in the same way as reading the analog content of a printed page in a paper-based book. An eReader provides a convenient format to store, transport, and view a large collection of digital content that would otherwise potentially take up a large volume of space in traditional paper format.

In some instances, eReaders are purpose built devices designed to perform especially well at displaying alphanumeric digital content (e.g., text). For example, a purpose built eReader may include a display that reduces glare, performs well in high light conditions, and/or mimics the look of printed text on actual paper. While such purpose built eReaders may excel at displaying alphanumeric digital content for a user to read, they may also perform other functions, such as displaying graphic images, emitting audio, capturing audio, capturing digital images, and web surfing, among others.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1A shows a front perspective view of an electronic reader (eReader), in accordance with various embodiments.

FIG. 1B shows a rear perspective view of the eReader of FIG. 1A, in accordance with various embodiments.

FIG. 2 shows a cross-section of the eReader of FIG. 1A along with a detail view of a portion of the display of the eReader, in accordance with various embodiments.

FIG. 3 shows a cutaway view of an eReader illustrating one example of a touch sensor, in accordance with an embodiment.

FIG. 4 shows an example computing system which may be included as a component of an eReader, according to various embodiments.

FIG. 5 shows a block diagram of an automatic next-read eBook provider system, according to various embodiments.

FIG. 6 illustrates a flow diagram of a method for automatically selecting and downloading a next-read eBook to an electronic reading device, according to various embodiments.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “capturing”, “determining”, “outputting”, “inputting”, “providing”, “receiving”, “utilizing”, “accessing”, “selecting”, “downloading”, “finishing” or the like, often refer to the actions and processes of an electronic computing device/system, such as a mobile phone, an electronic personal display, and/or a mobile (i.e., handheld) multimedia device, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

### Overview of Discussion

An eReader presents digital content to a user in a page format that allows the digital content to be read by a user in a similar fashion as reading a page in a paper-based book. Thus, in an embodiment, an eReader renders the digital content in discreet pages analogous to a conventional paper book. However, since the book is a digital book, the eReader can accurately track a user's progress through the eBook.

One embodiment focuses on a user's progressive reading through the eBook such that when the user reaches the last page of the current eBook, another related next-read eBook is presented for reading without any user interaction. In general, the related eBook may be the next book in a sequence of books, a book written by the same author, another book involving a same fictional character, and the like. In another embodiment, the next-read eBook may be identified automatically as the next read via a content discovery/recommendations engine used in conjunction with a server-based digital content store accessible via a communication network.

In one embodiment, the next read eBook is downloaded from an eBook repository before the user reaches the last page (or next-to-last page, etc.) of the current eBook. However, the next read eBook is not presented to the user until it is estimated that the user has completed reading the last page of the current eBook. In so doing, presentation of the next-read eBook is done in an unobtrusive manner.

In one embodiment, after the user accesses the next-read eBook for a pre-defined use metric, the purchase of said next read eBook is consummated. For example, by a user account including credit card or financial info sufficient to consummate the purchase transaction that is active and pre-established with the on-line eBook repository.

The discussion will begin with description of an example eReader and various components that may be included in some embodiments of an eReader. Various display and touch sensing technologies that may be utilized with some embodiments of an eReader will then be described. An example computing system, which may be included as a component of an eReader, will then be described. Operation of an example eReader and several of its components will then be described in more detail in conjunction with a description of an example method of utilizing a non-screen capacitive touch surface for operating an electronic personal display.

### Example Electronic Reader (eReader)

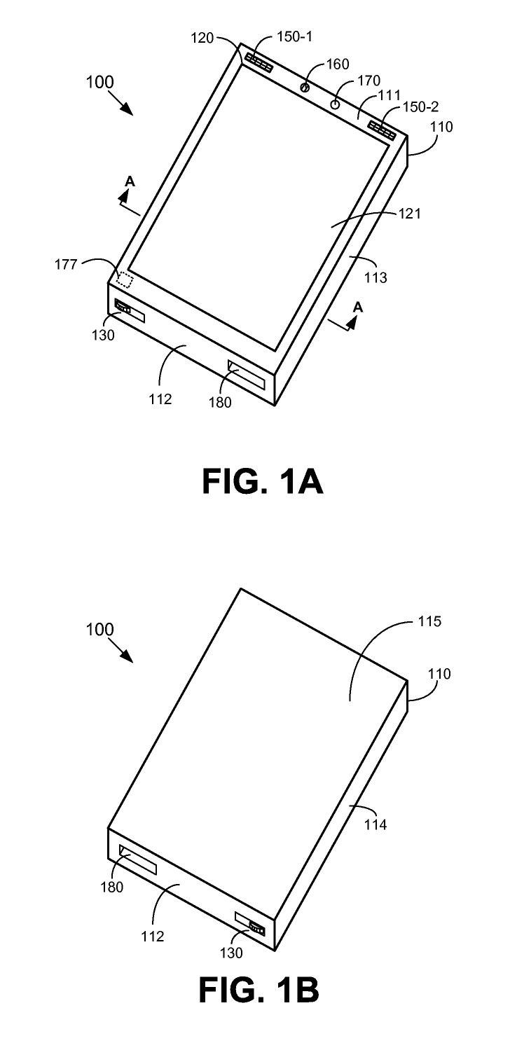

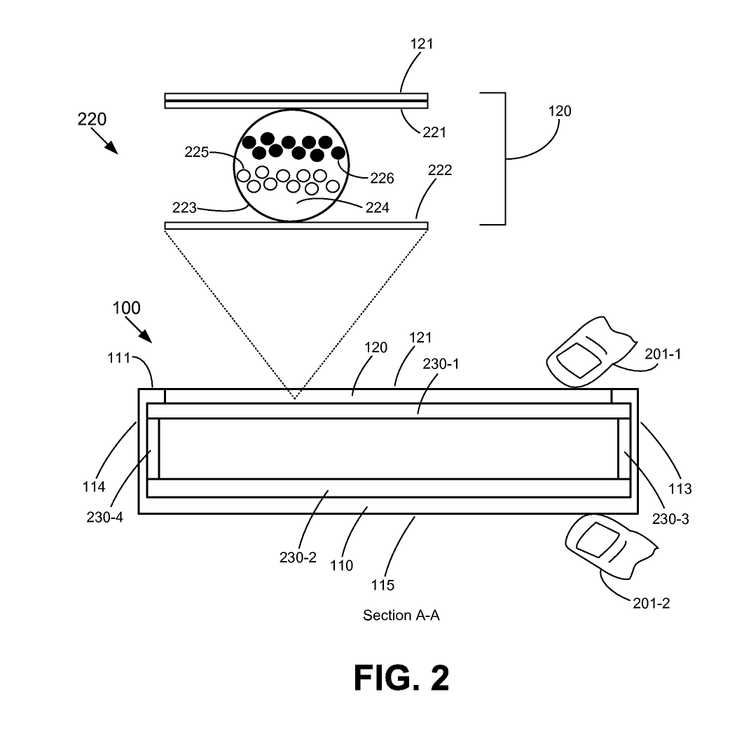

FIG. 1A shows a front perspective view of an eReader 100, in accordance with various embodiments. In general, eReader 100 is one example of an electronic personal display. Although an eReader is discussed specifically herein for purposes of example, concepts discussed are equally applicable to other types of electronic personal displays such as, but not limited to, mobile digital devices/tablet computers and/or multimedia smart phones. As depicted, eReader 100 includes a display 120, a housing 110, and some form of on/off switch 130. In some embodiments, eReader 100 may optionally include one or more of: speakers 150 (150-1 and 150-2 depicted), microphone 160, digital camera 170, 3D motion sensor 175, motion sensing device 177 and removable storage media slot 180. Section lines depict a region and direction of a section A-A which is shown in greater detail in FIG. 2.

Housing 110 forms an external shell in which display 120 is situated and which houses electronics and other components that are included in an embodiment of eReader 100. In FIG. 1A, a front surface 111, a bottom surface 112, and a right side surface 113 are visible. Although depicted as a single piece, housing 110 may be formed of a plurality of joined or inter-coupled portions. Housing 110 may be formed of a variety of materials such as plastics, metals, or combinations of different materials.

Display 120 has an outer surface 121 (sometimes referred to as a bezel) through which a user may view digital contents such as alphanumeric characters and/or graphic images that are displayed on display 120. Display 120 may be any one of a number of types of displays including, but not limited to: a liquid crystal display, a light emitting diode display, a plasma display, a bistable display or other display suitable for creating graphic images and alphanumeric characters recognizable to a user.

On/off switch 130 is utilized to power on/power off eReader 100. On/off switch 130 may be a slide switch (as depicted), button switch, toggle switch, touch sensitive switch, or other switch suitable for receiving user input to power on/power off eReader 100.

Speaker(s) 150, when included, operates to emit audible sounds from eReader 100. A speaker 150 may reproduce sounds from a digital file stored on or being processed by eReader 100 and/or may emit other sounds as directed by a processor of eReader 100.

Microphone 160, when included, operates to receive audible sounds from the environment proximate eReader 100. Some examples of sounds that may be received by microphone 160 include voice, music, and/or ambient noise in the area proximate eReader 100. Sounds received by microphone 160 may be recorded to a digital memory of eReader 100 and/or processed by a processor of eReader 100.

Digital camera 170, when included, operates to receive images from the environment proximate eReader 100. Some examples of images that may be received by digital camera 170 include an image of the face of a user operating eReader 100 and/or an image of the environment in the field of view of digital camera 170. Images received by digital camera 170 may be still or moving and may be recorded to a digital memory of eReader 100 and/or processed by a processor of eReader 100.

Motion sensing device 177, which monitors movement of eReader 100. Motion sensing device 177 may be a single motion sensor or a plurality of motion sensors. In one embodiment, motion sensing device 177 is selected from the group consisting of: an accelerometer, a magnetometer, a gyroscope. In an embodiment, motion sensing device 177 may be digital camera 170.

Some examples of movement that may be detected include swivel (e.g., sideways movements), tilt (e.g., up and down movements), rotation (e.g., back and forth movements) and a combination of the movements. Granularity with respect to the level of movement detected by motion sensing device 177 may be preset or user adjustable. Movements detected by motion sensing device 177 may be recorded to a digital memory of eReader 100 and/or processed by a processor of eReader 100. In one embodiment, motion sensing device 177 is fixedly coupled within the housing 110 of eReader 100. However, in another embodiment, motion sensing device 177 may be removably coupled with eReader 100 such as a wired or wireless connection.

Removable storage media slot 180, when included, operates to removably couple with and interface to an inserted item of removable storage media, such as a non-volatile memory card (e.g., MultiMediaCard (“MMC”), a secure digital (“SD”) card, or the like). Digital content for play by eReader 100 and/or instructions for eReader 100 may be stored on removable storage media inserted into removable storage media slot 180. Additionally or alternatively, eReader 100 may record or store information on removable storage media inserted into removable storage media slot 180.

FIG. 1B shows a rear perspective view of eReader 100 of FIG. 1A, in accordance with various embodiments. In FIG. 1B, a rear surface 115 of the non-display side of the housing 110 of eReader 100 is visible. Also visible in FIG. 1B is a left side surface 114 of housing 110. It is appreciated that housing 110 also includes a top surface which is not visible in either FIG. 1A or FIG. 1B.

FIG. 2 shows a cross-section A-A of eReader 100 along with a detail view 220 of a portion of display 120, in accordance with various embodiments. In addition to display 120 and housing 110, a plurality of touch sensors 230 are visible and illustrated in block diagram form. It should be appreciated that a variety of well-known touch sensing technologies may be utilized to form touch sensors 230 that are included in embodiments of eReader 100; these include, but are not limited to: resistive touch sensors; capacitive touch sensors (using self and/or mutual capacitance); inductive touch sensors; and infrared touch sensors. In general, resistive touch sensing responds to pressure applied to a touched surface and is implemented using a patterned sensor design on, within, or beneath display 120, rear surface 115, and/or other surface of housing 110. In general, inductive touch sensing requires the use of a stylus and are implemented with a patterned electrode array disposed on, within, or beneath display 120, rear surface 115, and/or other surface of housing 110 In general, capacitive touch sensing utilizes a patterned electrode array disposed on, within, or beneath display 120, rear surface 115, and/or other surface of housing 110; and the patterned electrodes sense changes in capacitance caused by the proximity or contact by an input object. In general, infrared touch sensing operates to sense an input object breaking one or more infrared beams that are projected over a surface such as outer surface 121, rear surface 115, and/or other surface of housing 110.

Once an input object interaction is detected by a touch sensor 230, it is interpreted either by a special purpose processor (e.g., an application specific integrated circuit (ASIC)) that is coupled with the touch sensor 230 and the interpretation is passed to a processor of eReader 100, or a processor of eReader is used to directly operate and/or interpret input object interactions received from a touch sensor 230. It should be appreciated that in some embodiments, patterned sensors and/or electrodes may be formed of optically transparent material such as very thin wires or a material such as indium tin oxide (ITO).

In various embodiments one or more touch sensors 230 (230-1 front; 230-2 rear; 230-3 right side; and/or 230-4 left side) may be included in eReader 100 in order to receive user input from input object 201 such as styli or human digits. For example, in response to proximity or touch contact with outer surface 121 or coversheet (not illustrated) disposed above outer surface 121, user input from one or more fingers such as finger 201-1 may be detected by touch sensor 230-1 and interpreted. Such user input may be used to interact with graphical content displayed on display 120 and/or to provide other input through various gestures (e.g., tapping, swiping, pinching digits together on outer surface 121, spreading digits apart on outer surface 121, or other gestures).

In a similar manner, in some embodiments, a touch sensor 230-2 may be disposed proximate rear surface 115 of housing 110 in order to receive user input from one or more input objects 201, such as human digit 201-2. In this manner, user input may be received across all or a portion of the rear surface 115 in response to proximity or touch contact with rear surface 115 by one or more user input objects 201. In some embodiments, where both front (230-1) and rear (230-2) touch sensors are included, a user input may be received and interpreted from a combination of input object interactions with both the front and rear touch sensors.

In a similar manner, in some embodiments, a left side touch sensor 230-3 and/or a right side touch sensor 230-4, when included, may be disposed proximate the respective left and/or right side surfaces (113, 114) of housing 110 in order to receive user input from one or more input objects 201. In this manner, user input may be received across all or a portion of the left side surface 113 and/or all or a portion of the right side surface 114 of housing 110 in response to proximity or touch contact with the respective surfaces by or more user input objects 201. In some embodiments, instead of utilizing a separate touch sensor, a left side touch sensor 230-3 and/or a right side touch sensor 230-4 may be a continuation of a front touch sensor 230-1 or a rear touch sensor 230-2 which is extended so as to facilitate receipt proximity/touch user input from one or more sides of housing 110.

Although not depicted, in some embodiments, one or more touch sensors 230 may be similarly included and situated in order to facilitate receipt of user input from proximity or touch contact by one or more user input objects 201 with one or more portions of the bottom 112 and/or top surfaces of housing 110.

Referring still to FIG. 2, a detail view 220 is show of display 120, according to some embodiments. Detail 220 depicts a portion of a bistable electronic ink that is used, in some embodiments, when display 120 is a bistable display. In some embodiments, a bistable display is utilized in eReader 100 as it presents a paper and ink like image and/or because it is a reflective display rather than an emissive display and thus can present a persistent image on display 120 even when power is not supplied to display 120. In one embodiment, a bistable display comprises electronic ink the form of millions of tiny optically clear capsules 223 that are filled with an optically clear fluid 224 in which positively charged white pigment particles 225 and negatively charged black pigment particles 226 are suspended. The capsules 223 are disposed between bottom electrode 222 and a transparent top electrode 221. A transparent/optically clear protective surface is often disposed over the top of top electrode 221 and, when included, this additional transparent surface forms outer surface 121 of display 120 and forms a touch surface for receiving touch inputs. It should be appreciated that one or more intervening transparent/optically clear layers may be disposed between top electrode 221 and top electrode 221. In some embodiments, one or more of these intervening layers may include a patterned sensor and/or electrodes for touch sensor 230-1. When a positive or negative electric field is applied proximate to each of bottom electrode 222 and top electrode 221 in regions proximate capsule 223, pigment particles of opposite polarity to a field are attracted to the field, while pigment particles of similar polarity to the applied field are repelled from the field. Thus, when a positive charge is applied to top electrode 221 and a negative charge is applied to bottom electrode 221, black pigment particles 226 rise to the top of capsule 223 and white pigment particles 225 go to the bottom of capsule 223. This makes outer surface 121 appear black at the point above capsule 223 on outer surface 121. Conversely, when a negative charge is applied to top electrode 221 and a positive charge is applied to bottom electrode 221, white pigment particles 225 rise to the top of capsule 223 and black pigment particles 226 go to the bottom of capsule 223. This makes outer surface 121 appear white at the point above capsule 223 on outer surface 121. It should be appreciated that variations of this technique can be employed with more than two colors of pigment particles.

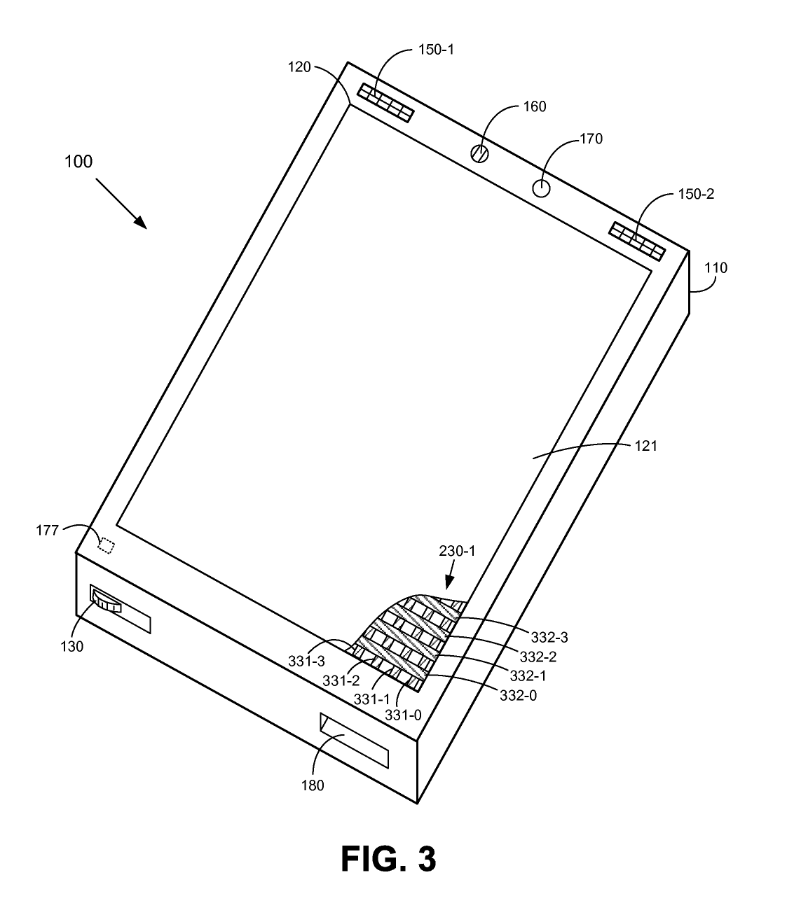

FIG. 3 shows a cutaway view of an eReader illustrating one example of a touch sensor 230, in accordance with an embodiment. In FIG. 3, a portion of display 120 has been removed such that a portion of underlying top sensor 230-1 is visible. As depicted, in one embodiment, top touch sensor 230-1 is illustrated as an x-y grid of sensor electrodes which may be used to perform various techniques of capacitive sensing. For example, sensor electrodes 331 (331-0, 331-1, 331-2, and 331-3 visible) are arrayed along a first axis, while sensor electrodes 332 (332-0, 332-1, 332-2, and 332-3 visible) are arrayed along a second axis that is approximately perpendicular to the first axis. It should be appreciated that a dielectric layer (not illustrated) is disposed between all or portions of sensor electrodes 331 and 332 to prevent shorting. It should also be appreciated that the pattern of sensor electrodes (331, 332) illustrated in FIG. 3 has been provided an example only, that a variety of other patterns may be similarly utilized, and some of these patterns may only utilize sensor electrodes disposed in a single layer. Additionally, while the example of FIG. 3 illustrates top sensor 230-1 as being disposed beneath display 120, in other embodiments, portions of touch sensor 230-1 may be transparent and disposed either above display 120 or integrated with display 120.

In one embodiment, by performing absolute/self-capacitive sensing with sensor electrodes 331 on the first axis a first profile of any input object contacting outer surface 121 can be formed, and then a second profile of any input object contacting outer surface 121 can be formed on an orthogonal axis by performing absolute/self-capacitive sensing on sensor electrodes 332. These capacitive profiles can be processed to determine an occurrence and/or location of a user input with made by means of an input object 201 contacting or proximate outer surface 121.

In another embodiment, by performing transcapacitive/mutual capacitive sensing between sensor electrodes 331 on the first axis and sensor electrodes 332 on the second axis a capacitive image can be formed of any input object contacting outer surface 121. This capacitive image can be processed to determine occurrence and/or location of user input made by means of an input object contacting or proximate outer surface 121.

It should be appreciated that mutual capacitive sensing is regarded as a better technique for detecting multiple simultaneous input objects in contact with a surface such as outer surface 121, while absolute capacitive sensing is regarded as a better technique for proximity sensing of objects which are near but not necessarily in contact with a surface such as outer surface 121.

In some embodiments, capacitive sensing and/or another touch sensing technique may be used to sense touch input across all or a portion of the rear surface 115 of eReader 100, and/or any other surface(s) of housing 110.

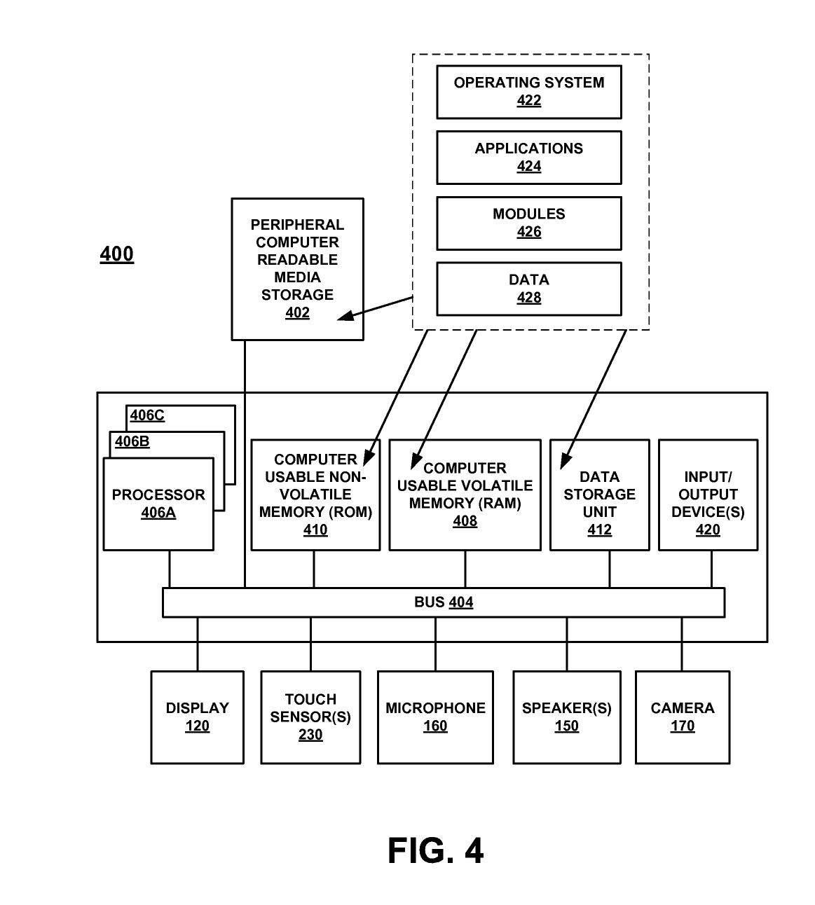

FIG. 4 shows an example computing system 400 which may be included as a component of an eReader, according to various embodiments and with which or upon which various embodiments described herein may operate.

### Example Computer System Environment

With reference now to FIG. 4, all or portions of some embodiments described herein are composed of computer-readable and computer-executable instructions that reside, for example, in computer-usable/computer-readable storage media of a computer system. That is, FIG. 4 illustrates one example of a type of computer (computer system 400) that can be used in accordance with or to implement various embodiments of an eReader, such as eReader 100, which are discussed herein. It is appreciated that computer system 400 of FIG. 4 is only an example and that embodiments as described herein can operate on or within a number of different computer systems.

System 400 of FIG. 4 includes an address/data bus 404 for communicating information, and a processor 406A coupled to bus 404 for processing information and instructions. As depicted in FIG. 4, system 400 is also well suited to a multi-processor environment in which a plurality of processors 406A, 406B, and 406C are present. Processors 406A, 406B, and 406C may be any of various types of microprocessors. For example, in some multi-processor embodiments, one of the multiple processors may be a touch sensing processor and/or one of the processors may be a display processor. Conversely, system 400 is also well suited to having a single processor such as, for example, processor 406A. System 400 also includes data storage features such as a computer usable volatile memory 408, e.g., random access memory (RAM), coupled to bus 404 for storing information and instructions for processors 406A, 406B, and 406C. System 400 also includes computer usable non-volatile memory 410, e.g., read only memory (ROM), coupled to bus 404 for storing static information and instructions for processors 406A, 406B, and 406C. Also present in system 400 is a data storage unit 412 (e.g., a magnetic or optical disk and disk drive) coupled to bus 404 for storing information and instructions.

Computer system 400 of FIG. 4 is well adapted to having peripheral computer-readable storage media 402 such as, for example, a floppy disk, a compact disc, digital versatile disc, universal serial bus “flash” drive, removable memory card, and the like coupled thereto. In some embodiments, computer-readable storage media 402 may be coupled with computer system 400 (e.g., to bus 404) by insertion into removable a storage media slot, such as removable storage media slot 180 depicted in FIGS. 1A and 1B.

System 400 also includes or couples with display 120 for visibly displaying information such as alphanumeric text and graphic images. In some embodiments, system 400 also includes or couples with one or more optional sensors 430 for communicating information, cursor control, gesture input, command selection, and/or other user input to processor 406A or one or more of the processors in a multi-processor embodiment. In general, optional sensors 420 may include, but is not limited to, touch sensor 230, 3D motion sensor 175, motion sensing device 177 and the like. In some embodiments, system 400 also includes or couples with one or more optional speakers 150 for emitting audio output. In some embodiments, system 400 also includes or couples with an optional microphone 160 for receiving/capturing audio inputs. In some embodiments, system 400 also includes or couples with an optional digital camera 170 for receiving/capturing digital images as an input.

Optional sensor(s) 430 allows a user of computer system 400 (e.g., a user of an eReader of which computer system 400 is a part) to dynamically signal the movement of a visible symbol (cursor) on display 120 and indicate user selections of selectable items displayed on display 120. In some embodiment other implementations of a cursor control device and/or user input device may also be included to provide input to computer system 400, a variety of these are well known and include: trackballs, keypads, directional keys, and the like. System 400 is also well suited to having a cursor directed or user input received by other means such as, for example, voice commands received via microphone 160. System 400 also includes an input/output (I/O) device 420 for coupling system 400 with external entities. For example, in one embodiment, I/O device 420 is a modem for enabling wired communications or modem and radio for enabling wireless communications between system 400 and an external device and/or external network such as, but not limited to, the Internet. I/O device 120 may include a short-range wireless radio such as a Bluetooth® radio, Wi-Fi radio (e.g., a radio compliant with Institute of Electrical and Electronics Engineers' (IEEE) 802.11 standards), or the like.

Referring still to FIG. 4, various other components are depicted for system 400. Specifically, when present, an operating system 422, applications 424, modules 426, and/or data 428 are shown as typically residing in one or some combination of computer usable volatile memory 408 (e.g., RAM), computer usable non-volatile memory 410 (e.g., ROM), and data storage unit 412. In some embodiments, all or portions of various embodiments described herein are stored, for example, as an application 424 and/or module 426 in memory locations within RAM 408, ROM 410, computer-readable storage media within data storage unit 412, peripheral computer-readable storage media 402, and/or other tangible computer readable storage media.

### Operation

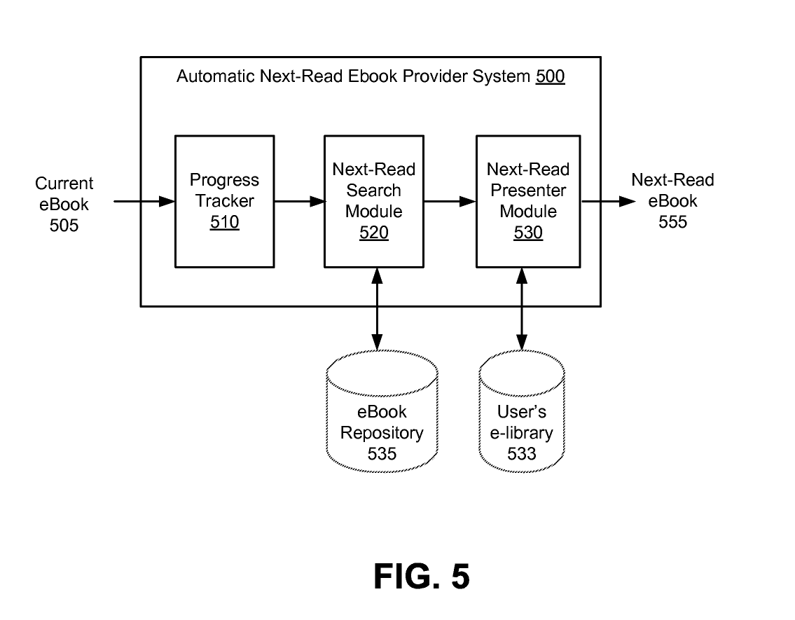

Referring now to FIG. 5, an automatic next-read eBook provider system 500 is shown, in accordance with various embodiments. In one embodiment, automatic next-read eBook provider system 500 includes a progress tracker 510, a next-read search module 520, and a next-read presenter module 530. In one embodiment, the components of automatic next-read eBook provider system 500 may be located in a single device. In another embodiment, one or more of the components of automatic next-read eBook provider system 500 may be found in different locations and/or on different devices.

In one embodiment, progress tracker 510 tracks a user's reading progress for the current eBook 505 accessed on an electronic reader (eReader). In one embodiment, progress tracker 510 provides reading progress information about current eBook 505 to next-read search module 520. Next-read search module 520 utilizes the progress information from progress tracker 510 to select next-read eBook 555 based on an aspect of current eBook 505. Next-read eBook presentation module 530 receives information about next-read eBook 555 and progress tracker information from next-read search module 520 and automatically presents next-read eBook 555 when the user's reading progress shows completion of current eBook 505.

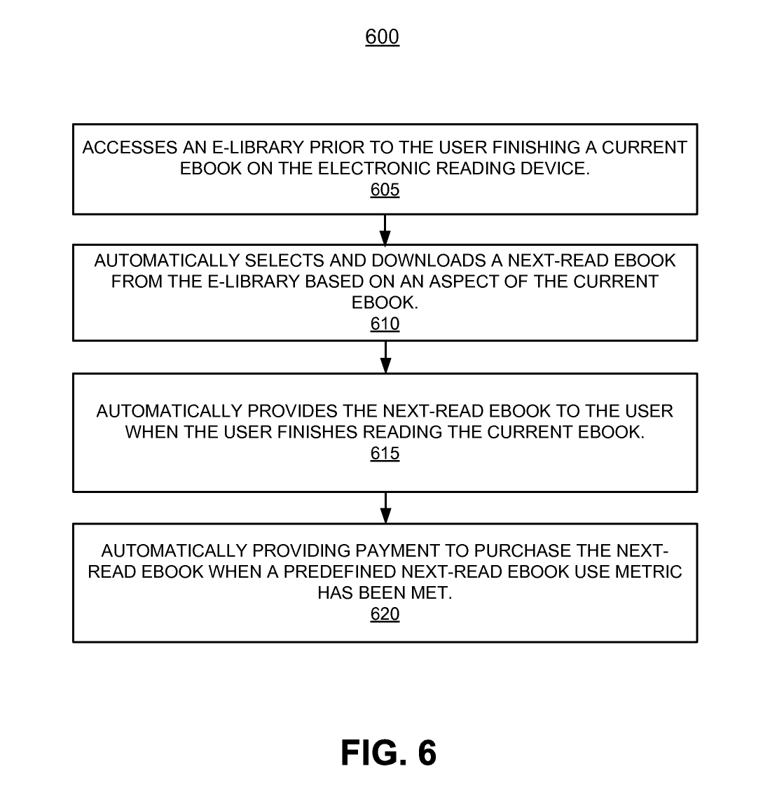

With reference now to FIG. 6, a flow diagram 600 of a method for automatically selecting and downloading a next-read eBook to an electronic reading device is shown according to various embodiments. In one embodiment, flowchart 600 may be performed by an electronic personal display, such as a phone, tablet, electronic reader (eReader), or the like.

With reference now to 605 of FIG. 6 and to FIG. 1A and FIG. 1B, one embodiment accesses an e-library prior to the user finishing a current eBook on the electronic reading device. For example, progress tracker 510 will track a user's reading progress, automatic next-read eBook provider system 500 can ascertain a number of reading metrics about the current eBook 505. For example, progress tracker 510 can determine the speed at which the user is reading the current eBook 505, how far along the user has progressed through current eBook 505, and the like. In so doing, progress tracker 510 can determine if the user is just starting current eBook 505, halfway through current eBook 505, close to finishing current eBook 505 or the like. In addition, in one embodiment, progress tracker 510 can use the progress data to determine the user's interest in the current eBook 505. For example, a user that is not enjoying the current eBook 505 may be progressing at a slower than usual pace, taking a lot of breaks from reading, or the like. In contrast, a user that is enjoying current eBook 505 may be reading at a faster than usual pace, taking fewer breaks from reading, and the like.

Moreover, in one embodiment, the user may be reading more than one current eBook 505 at a time. For example, a user may start a first eBook and then stop reading the first eBook and begin reading a second eBook. The user may then consistently continue reading the second eBook without returning to the first eBook. In so doing, progress tracker 510 would determine that the second current eBook 505 is of more interest to the user.

Referring now to 610 of FIG. 6 and to FIG. 5, one embodiment automatically selects and downloads a next-read eBook from the e-library based on an aspect of the current eBook. In one embodiment, the automatic downloading of the next-read eBook is from eBook repository 535 in a cloud repository to user's e-library 533 of the electronic reading device.

For example, next-read search module 520 utilizes the progress information from progress tracker 510 to determine a next-read eBook based on an aspect of current eBook 505. In general, the aspect of the current eBook used to determine the next-read eBook may include, but is not limited to, an author of the current eBook, a character in the current eBook, a sequential relationship between the current eBook and the next-read eBook, or the like.

In another embodiment, next-read search module 520 utilizes a recommendation engine to select the next-read eBook. That is, next-read search module 520 would look at reviews and recommendations from others that have read current eBook 505. Next-read search module 520 may then select the next-read eBook 555 based on recommendations, purchase history, and the like associated with the current eBook. For example, next-read search module 520 may determine that 80% of readers that have purchased current eBook 505 have gone on to purchase next-read eBook 555. In another example, next-read search module 520 determines that 65% of readers that have purchased current eBook 505 recommend next-read eBook 555 as a comparable read.

In one embodiment, after selecting next-read eBook 555, next-read search module 520 accesses an eBook repository 535 to obtain next-read eBook 555. Next-read search module 520 downloads next-read eBook 555 to the eReader user's e-library 533. In one embodiment, next-read search module 520 completes the selection and downloading of next-read eBook 555 prior to the user's reading progress showing a completion of current eBook 505.

In one embodiment, eBook repository 535 may be a single server, but in another embodiment, eBook repository 535 may be a vast array of servers accessible via the Internet. In general, eBook repository 535 may be a database of any number of available eBooks.

With reference now to 615 of FIG. 6 and to FIG. 5, one embodiment automatically provides the next-read eBook to the user when the user finishes reading the current eBook. For example, next-read eBook presentation module 530 receives information about next-read eBook 555 and progress tracker information from next-read search module 520 and automatically presents next-read eBook 555 when the user's reading progress shows completion of current eBook 505. In one embodiment, next-read presenter module 530 automatically presents the next-read eBook based on a time-to-completion determination. For example, the time-to-completion determination utilizes a comparison between an amount of text rendered on a last page of the current eBook and the user's average reading progress. Thus, if the user reads 100 words per minute and the final page of text rendered includes 400 words, then time-to-completion determiner would determine that the user would be finished reading in 4 minutes.

Referring now to 620 of FIG. 6 and to FIG. 5, one embodiment automatically provides payment to purchase the next-read eBook when a predefined next-read eBook use metric has been met. For example, next-read presenter module 530 automatically authorizes the purchase of next-read eBook 555 when a predefined next-read eBook use metric has been met.

In one embodiment, the predefined next-read eBook use metric measures a number of pages read. For example, a user may finish reading current eBook 505 and be presented with next-read eBook 555. The user would have a pre-defined number of pages to read before next-read eBook 555 is purchased. If the user reads more than the pre-defined number of pages, then next-read presenter module 530 will authorize the purchase of next-read eBook 555. For example, if the pre-defined number of pages is 30, then the user would be able to read the first 29 pages of next-read eBook 555 without incurring any expense. However, when the user continues to page 30 of next-read eBook 555 the purchase would be consummated. In so doing, the user would be provided with a preview period before having to purchase the eBook.

In another embodiment, the predefined next-read eBook use metric measures an amount of time since next-read eBook 555 has been accessed. For example, after the user finished current eBook 505 and opens next-read eBook 555 a pre-defined time period would begin to toll. In one embodiment, the pre-defined time period metric is related to the pre-defined number of pages metric discussed above. In one embodiment, if the user has not read 30 pages of next-read eBook 555 within a pre-defined time period of 10 days, the user will be offered the opportunity to purchase next-read eBook 555. If the user opts out of the purchase, then next-read eBook 555 will be removed from user's e-library 533.

By utilizing the automatic selecting and downloading features of automatic next-read eBook provider system 500, the presentation of next-read eBook 555 is provided to the user in an unobtrusive manner. In addition, since the user has a period of evaluation time before consummating the purchase, the user would not be hesitant about employing the automatic next-read eBook provider system 500. An eBook seller would also embrace the automatic downloading with the associated trial period since they would be providing the next-read eBook 555 to a targeted audience.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A computer implemented method for automatically selecting and downloading a next-read electronic book (eBook) to an electronic reading device, said method comprising:
accessing an e-library prior to the user finishing a current eBook on the electronic reading device;
automatically selecting and downloading a next-read eBook from the e-library based on an aspect of the current eBook; and
automatically providing the next-read eBook to the user when the user finishes reading the current eBook; and
automatically providing payment to purchase the next-read eBook when a predefined next-read eBook use metric has been met.

2. The method of claim 1 further comprising:
automatically downloading the next-read eBook from the e-library in a cloud repository to a local storage of the electronic reading device.

3. The method of claim 1 further comprising:
selecting the next-read eBook based on an author of the current eBook.

4. The method of claim 1 further comprising:
selecting the next-read eBook based on a character in the current eBook.

5. The method of claim 1 further comprising:
selecting the next-read eBook based on a sequential relationship between the current eBook and the next-read eBook.

6. The method of claim 1 further comprising:
utilizing a recommendation engine for selecting the next-read eBook based on recommendations associated with the current eBook.

7. The method of claim 1 further comprising:
utilizing a number of pages read as the predefined next-read eBook use metric.

8. The method of claim 1 further comprising:
utilizing an amount of time since the next-read eBook has been accessed as the predefined next-read eBook use metric.

9. An automatic next-read eBook provider system comprising:
a progress tracker to track a user's reading progress of the current eBook accessed on an electronic reader (eReader);
a next-read search module to search for a next-read eBook based on an aspect of the current eBook and download the next-read eBook to the eReader prior to the user's reading progress showing a completing of the current eBook;
a next-read eBook presentation module to automatically present the next-read eBook when the user's reading progress shows completion of the current eBook and to purchase the next-read eBook when a predefined next-read eBook use metric has been met.

10. The system of claim 9 wherein the next-read search module automatically downloads the next-read eBook from an e-library in a cloud repository to a local storage of the eReader.

11. The system of claim 9 wherein the aspect of the current eBook is selected from the group consisting of: an author of the current eBook, a character in the current eBook, and a sequential relationship between the current eBook and the next-read eBook.

12. The system of claim 9 wherein the a next-read eBook presentation module automatically presents the next-read eBook based on a time-to-completion determination based on an amount of text rendered on a last page of the current eBook and the user's reading progress for the amount of text rendered.

13. The system of claim 9 wherein the next-read search module utilizes a recommendation engine to select the next-read eBook based on recommendations associated with the current eBook.

14. The system of claim 9 wherein the predefined next-read eBook use metric measures a number of pages read.

15. The system of claim 9 wherein the predefined next-read eBook use metric measures an amount of time since the next-read eBook has been accessed.

16. A computer implemented method for automatically loading a next-read electronic book (eBook) to an electronic reader (eReader), said method comprising:
monitoring a user's reading progress through a current eBook to determine when the user will finish reading the current eBook;
prior to the user finishing the current eBook, the method further comprises:
accessing an e-library in a cloud repository;
automatically selecting a next-read eBook to download based on an aspect of the current eBook; and
automatically downloading the next-read eBook from the e-library in the cloud repository to a local storage of the eReader prior to the user finishing the current eBook;
providing the next-read eBook to the user when the user finishes reading the current eBook; and
automatically providing, from the electronic reading device to the e-library, an authorization to purchase the next-read eBook when a predefined next-read eBook use metric has been met.

17. The method of claim 16 wherein the selecting of the next-read eBook is based the aspect of the current eBook selected from the group consisting of: an author of the current eBook and a character in the current eBook.

18. The method of claim 16 further comprising:
selecting the next-read eBook based on a sequential relationship between the current eBook and the next-read eBook.

19. The method of claim 16 further comprising:
utilizing a recommendation engine for selecting the next-read eBook based on recommendations associated with the current eBook.

20. The method of claim 16 wherein the predefined next-read eBook use metric is selected from the group consisting of: a number of pages read and an amount of time since the next-read eBook has been opened.
